(19) United States
(12) Patent Application Publication
(10) Pub. No.: US 2009/0000449 A1
(43) Pub. Date: Jan. 1, 2009

(54) Tightening device for positioning a worktable of a machine tool relative to a base

(75) Inventors: Chih-Cheng Lin, Taichung Hsien (TW); Msin-Msin Wang, Taichung Hsien (TW); Chun-Te Lee, Taichung City (TW); Hsin-Yi Cheng, Nan-Tou City (TW); Ming-Hui Huang, Taichung Hsien (TW); Jiann-Fang Chang, Taichung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: P & F Brother Industrial Corporation, Taichung (TW)

(21) Appl. No.: 11/824,010

(22) Filed: Jun. 29, 2007

(51) Int. Cl. B23D 33/02

(52) U.S. Cl. 83/471

(57) ABSTRACT

A tightening device for positioning a worktable of a machine tool to a base includes a saddle member disposed on the base, and a positioning carrier member carrying the worktable and movable relative to an abutment wall of the saddle member. An elongate adjusting member has a force-delivering end spaced apart from the abutment wall, and a middle threaded segment threadedly engaged with the positioning carrier member such that the force-delivering end is movable towards or away from the abutment wall. A force transmitting member is loosely connected to the positioning carrier member, and is configured such that a spiral force resulting from a screw-in movement is taken up by a proximate end thereof from the force-delivering end, and is transformed to a translation force that moves a distal end thereof to tightly engage the abutment wall.

### BACKGROUND OF THE INVENTION

1. Field of the Invention

This invention relates to a tightening device for positioning a worktable of a machine tool relative to a base, more particularly to a tightening device for positioning the worktable of the machine tool, such as a cutting machine, relative to the base, which permits easy determination of end of screw-in movement of an adjusting member.

2. Description of the Related Art

Referring to FIG. 1, a conventional cutting machine 10 is shown to include a base 11, a work table 12 which is pivotally connected to the base 11, and a screw tightening unit 13 which has a screw fastener 131 that is threadedly engaged with a lower portion of the worktable 12 such that a distal end of the screw fastener 131 can tightly abut against an abutment wall 111 of the base 11 by virtue of a screw-in movement of the screw fastener 131 to thereby tighten the worktable 12 to the base 11, and an operating handle 132 which is disposed at an operating end of the screw fastener 131 to be operated manually.

As the screw fastener 131 is disposed in the base 11 and is not visible, the operator rotates the screw fastener 131 to abut against the abutment wall 111 in accordance with his experience, which may result in application of an excess rotating force to the operating handle 132 to cause deformation of the screw fastener 131 and the worktable 12.

### SUMMARY OF THE INVENTION

The object of the present invention is to provide a tightening device permits easy determination of end of screw-in movement of an adjusting member, and which permits simple adjustment of a tightening force applied for positioning a worktable of a machine tool relative to a base.

According to this invention, the tightening device includes a saddle member which is adapted to be disposed on a base of a machine tool, and which has an abutment wall. A positioning carrier member is adapted to carry a worktable, and has a base mount disposed to be movable relative to the abutment wall, and a fore-end portion opposite to the base mount. An elongate adjusting member has operating and force-delivering ends opposite to each other in a lengthwise direction. The operating end is disposed outwardly of the fore-end portion. The force-delivering end is spaced apart from the abutment wall. The elongate adjusting member further has a middle threaded segment which is interposed between the operating and force-delivering ends, and which is threadedly engaged with the positioning carrier member such that the force-delivering end is movable towards or away from the abutment wall by virtue of screw-in and screw-out movements of the middle threaded segment. A force transmitting member is loosely connected to the positioning carrier member, and has proximate and distal ends opposite to each other. The force transmitting member is configured such that a spiral force resulting from the screw-in movement of the middle threaded segment is taken up by the proximate end from the force-delivering end, and is transformed to a translation force that moves the distal end forwards and in the lengthwise direction, thereby permitting the distal end to engage the abutment wall so as to tighten the positioning carrier member in an engaging position.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a fragmentary sectional schematic view of a worktable of a conventional cutting machine;

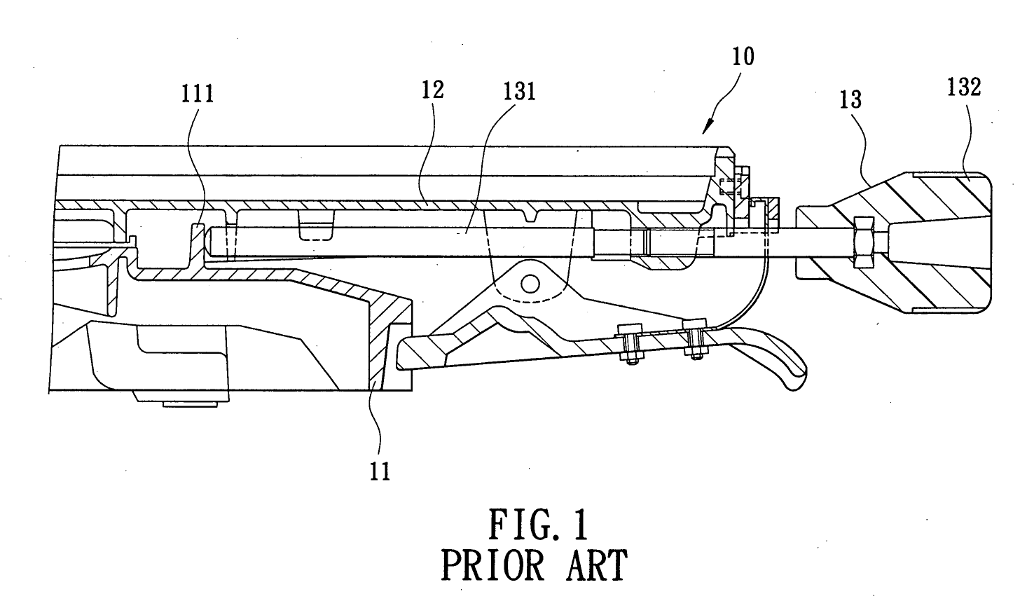

FIG. 2 is an exploded perspective view of the preferred embodiment of an endpoint-quick-detectable tightening device according to this invention;

FIG. 3 is a sectional view of the preferred embodiment in a ready-to-use state;

FIG. 4 is a top view of the preferred embodiment in the ready-to-use state;

FIG. 5 is a sectional view of the preferred embodiment in a tightening state; and

FIG. 6 is a fragmentary sectional view showing how a tightening force adjusting unit of the preferred embodiment is adjusted.

### DETAILED DESCRIPTION OF THE PREFERRED EMBODIMENT

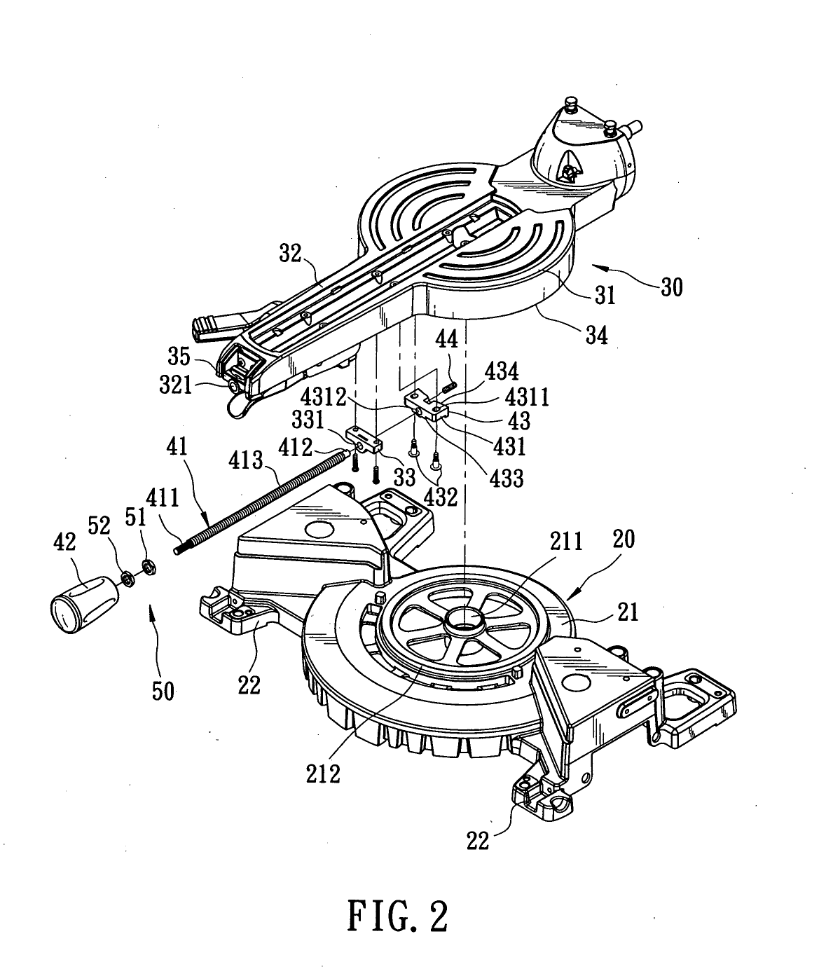

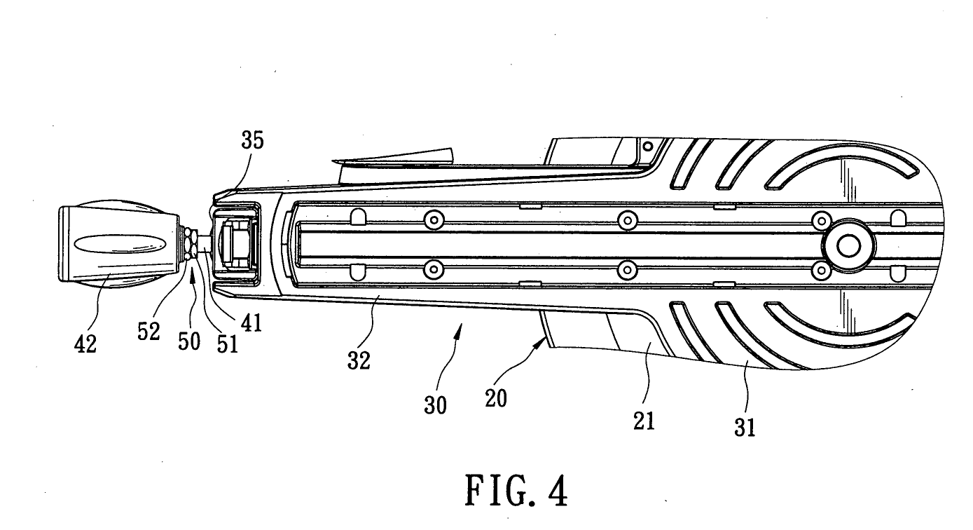

Referring to FIGS. 2 to 4, the preferred embodiment of a tightening device according to the present invention is used for positioning a worktable 31 of a machine tool, such as a cutting machine, relative to a base 20. In this embodiment, the base 20 is supported by two feet 22. The tightening device is shown to comprise a saddle member 21, a positioning carrier member 30, an elongate adjusting member 41, a force transmitting member 43, a biasing member 44, and a tightening force adjusting unit 50.

The saddle member 21 is adapted to be disposed on the base 20, and has a center hole 211 which extends along a centerline, and an abutment wall 212 which is disposed to surround the center hole 211.

The positioning carrier member 30 is adapted to carry the worktable 31, and has a base mount 34 which is pivotally connected to the center hole 211 to be rotatable relative to the abutment wall 212 so as to angularly adjust an engaging position of the worktable 31 about the centerline for adjusting a working angle of a workpiece (not shown) held on the worktable 31. The positioning carrier member 30 further has a fore-end portion 35 which is opposite to the base mount 34 in a lengthwise direction radial to the centerline, and an extending support 32 which is interposed between the fore-end portion 35 and the base mount 34, and which has a screw hole 321 that extends in the lengthwise direction through the fore-end portion 35. Further, a seat 33 is mounted on a lower portion of the extending support 32, and has a screw hole 331 extending through the seat 33 in the lengthwise direction.

The elongate adjusting member 41 has operating and force-delivering ends 411, 412 which are opposite to each other in the lengthwise direction, and a middle threaded segment 413 which is interposed between the operating and force-delivering ends 411, 412, and which is threadedly engaged with the screw holes 321, 331 in the positioning carrier member 30, such that the operating end 411 is disposed outwardly of the fore-end portion 35, and the force-delivering end 412 is spaced apart from the abutment wall 212. Thus, the force-delivering end 412 is movable towards or away from the abutment wall 212 by virtue of screw-in and screw-out movements of the middle threaded segment 413. An enlarged handle 42 is mounted on the operating end 411 to be operated manually.

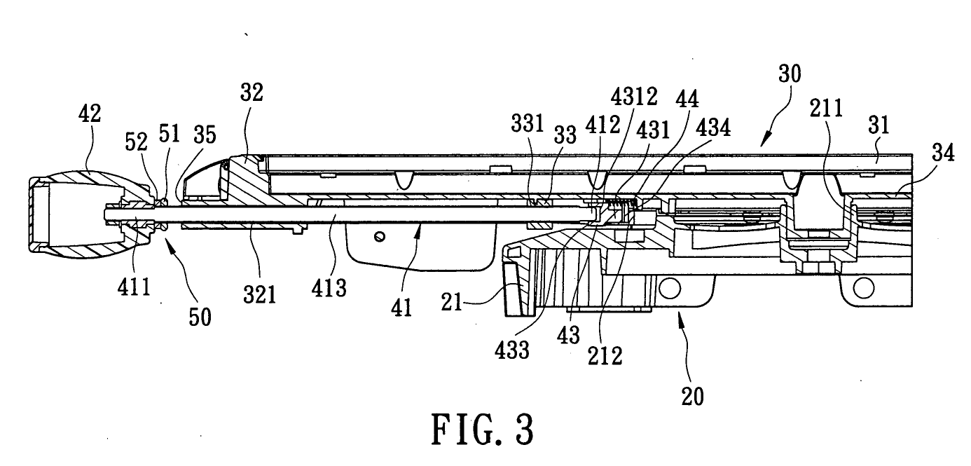

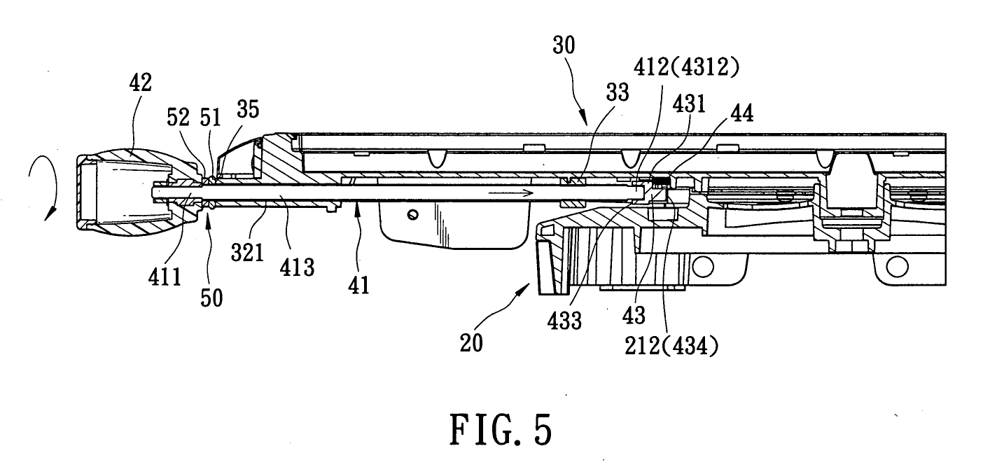

The force transmitting member 43 includes a connecting portion 431 which has two elongate slots 4311 each extending in the elongate direction, and two fasteners 432 that are extended through the elongate slots 4311, respectively, to loosely connect the force transmitting member 43 to the positioning carrier member 30, thereby permitting the force transmitting member 43 to be movable relative to the positioning carrier member 30 in the lengthwise direction. The force transmitting member 43 further includes proximate and distal ends 433, 434 opposite to each other, and a recess 4312 which extends from the proximate end 433 toward the distal end 434 for engagement with the force-delivering end 412 of the elongate adjusting member 41. Thus, as shown in FIGS. 3 and 5, by means of the loose connection of the force transmitting member 43 to the positioning carrier member 30, and by means of the engagement of the force-delivering end 412 with the recess 4312, a spiral force resulting from the screw-in movement of the middle threaded segment 413 of the elongate adjusting member 41 is taken up by the proximate end 433 from the force-delivering end 412, and is transformed to a translation force that moves the distal end 434 forwards and in the lengthwise direction, thereby permitting the distal end 434 to engage the abutment wall 212 so as to tighten the positioning carrier member 30 in a desired engaging position.

The biasing member 44 is disposed to bias the proximate end 434 of the force transmitting member 43 towards the force-delivering end 412 of the elongate adjusting member 41 in the lengthwise direction.

The tightening force adjusting unit 50 includes first and second nuts 51, 52. The first nut 51 is threadedly engaged with the middle threaded segment 413, and is disposed between the operating end 411 and the fore-end portion 35 such that, when the distal end 434 of the force transmitting member 43 is engaged with the abutment wall 212 to tighten the positioning carrier member 30 in the engaging position, the first nut 51 is engaged with the fore-end portion 35 so as to prevent further screw-in movement of the middle threaded segment 413. The second nut 52 is threadedly engaged with the middle threaded segment 413, and is juxtaposed to the first nut 51 to prevent undesired movement of the first nut 51 relative to the middle threaded segment 413. With the provision of the tightening force adjusting unit 50, the tightening force applied to the abutment wall 212 as a result of the screw-in movement of the middle threaded segment 413 is fixed. Hence, the deformation of the elongate adjusting member 41 and the worktable 31 can be prevented.

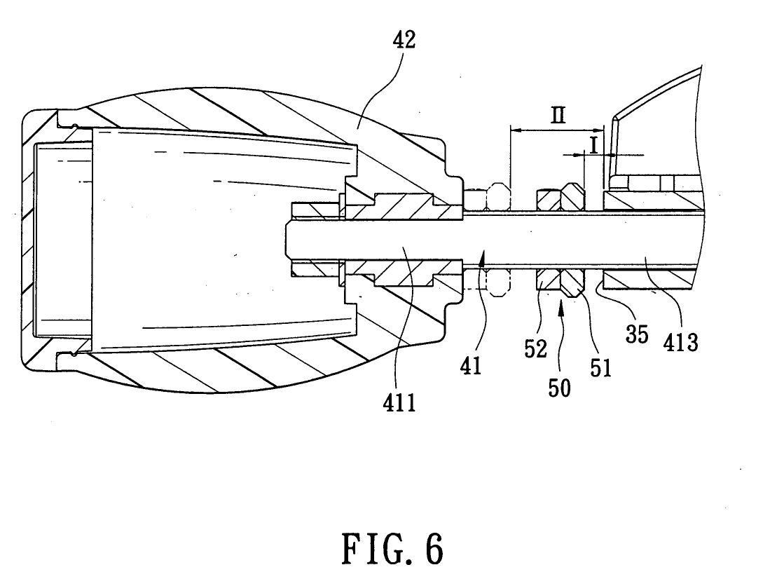

Referring to FIG. 6, when it is desired to adjust the tightening force for properly tightening the positioning carrier member 30 in the engaging position, the first and second nuts 51,52 are rotated relative to the fore-end portion 35 using a hand tool (not shown) such that there is a distance (I) between the first nut 51 and the fore-end portion 35 to allow application of a smaller tightening force to the positioning carrier member 30, or a distance (II) to allow application of a greater tightening force.

As illustrated, by providing the force transmitting member 43 and the biasing member 44, end of the screw-in movement of the elongate adjustable member 41 can be quickly determined by the operator to ensure a firm tightening engagement between the distal end 434 and the abutment wall 212. In addition, by providing the tightening force adjusting unit 50, a constant tightening force is maintained to prevent excess screw-in movement of the elongate adjusting member 41 and deformation of the worktable 31. Furthermore, the tightening force can be easily adjusted by adjusting the positions of the first and second nuts 51, 52 on the middle threaded segment 413.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

I claim:

1. A tightening device for positioning a worktable of a machine tool to a base, the worktable being movable relative to the base for adjusting an engaging position thereof to the base, said tightening device comprising:
a saddle member which is adapted to be disposed on the base, and which has an abutment wall;
a positioning carrier member which is adapted to carry the worktable, and which has a base mount disposed to be movable relative to said abutment wall, and a fore-end portion that is opposite to said base mount;
an elongate adjusting member which has operating and force-delivering ends that are opposite to each other in a lengthwise direction, said operating end being disposed outwardly of said fore-end portion, said force-delivering end being spaced apart from said abutment wall, said elongate adjusting member further having a middle threaded segment which is interposed between said operating and force-delivering ends, and which is threadedly engaged with said positioning carrier member such that said force-delivering end is movable towards or away from said abutment wall by virtue of screw-in and screw-out movements of said middle threaded segment; and
a force transmitting member which is loosely connected to said positioning carrier member, and which has proximate and distal ends opposite to each other, said force transmitting member being configured such that a spiral force resulting from the screw-in movement of said middle threaded segment is taken up by said proximate end from said force-delivering end, and is transformed to a translation force that moves said distal end forwards and in the lengthwise direction, thereby permitting said distal end to engage said abutment wall so as to tighten said positioning carrier member in the engaging position.

2. The tightening device of claim 1, wherein said abutment wall extends about a centerline of the base, said base mount being pivotally connected to said saddle member to be angularly movable about the centerline relative to said abutment wall, said fore-end portion being disposed opposite to said base mount in the lengthwise direction radial to the centerline, said positioning carrier member further has an extending support which is interposed between said fore-end portion and said base mount, and which has a screw hole that extends in the lengthwise direction through said fore-end portion such that said middle threaded segment of said elongated adjusting member is threadedly engaged with said screw hole.

3. The tightening device of claim 1, further comprising a biasing member which is disposed to bias said proximate end of said force transmitting member towards said force-delivering end of said elongate adjusting member in the lengthwise direction.

4. The tightening device of claim 3, wherein said force transmitting member has a recess which extends from said proximate end toward said distal end for engagement with said force-delivering end of said elongate adjusting member.

5. The tightening device of claim 4, wherein said force transmitting member has a connecting portion which has two elongate slots each extending in the elongate direction, and two fasteners that are extended through said elongate slots respectively to loosely connect said force transmitting member to said positioning carrier member, thereby permitting said force transmitting member to be movable relative to said positioning carrier member in the lengthwise direction.

6. The tightening device of claim 1, further comprising a tightening force adjusting unit that includes
a first nut which is threadedly engaged with said middle threaded segment, and which is disposed between said operating end and said fore-end portion such that when said distal end is engaged with said abutment wall to tighten said positioning carrier member in the engaging position, said first nut is engaged with said fore-end portion so as to prevent further screw-in movement of said middle threaded segment.

7. The tightening device of claim 6, wherein said tightening force adjusting unit further includes a second nut which is threadedly engaged with said middle threaded segment and which is juxtaposed to said first nut to prevent undesired movement of said first nut relative to said middle threaded segment.
